(19) United States
(12) Patent Application Publication
(10) Pub. No.: US 2025/0014269 A1
(43) Pub. Date: Jan. 9, 2025

(54) Method and Device for Generating Enhanced High-Fidelity Three-Dimensional Digital Duplicates of Real-World Objects

(71) Applicant: Max Adel Rady, Courbevoie (FR)

(72) Inventor: Max Adel Rady, Courbevoie (FR)

(21) Appl. No.: 18/348,850

(22) Filed: Jul. 7, 2023

(51) Int. Cl. G06T 17/00; G06T 7/50; G06T 7/80; H04N 23/10; H04N 23/56; H04N 23/695

(52) U.S. Cl. CPC G06T 17/00; G06T 7/50; G06T 7/80; H04N 23/10; H04N 23/56; H04N 23/695; G06T 2200/08; G06T 2207/10036

(57) ABSTRACT

A device and method for generating enhanced high-fidelity three-dimensional digital copies of real-world objects using a spectral imager, a range scanner, one or more polarizers and a mechanism of movement to move the real-world object and assessment devices relative to one another to allow a 360-degree assessment of the real-world object to determine the spectral hypercube data of the real-world object, including identifying individual layer composition and structure in multi-layered objects, and determining each layer at which sub-surface anomalies, defects, imperfections, noise and geometric irregularities in composition of the real-world object exist.

### FIELD OF THE INVENTION

This invention relates to the generation of enhanced high-fidelity three-dimensional digital duplicates/copies/reproductions/representations/models/twins (hereinafter “digital twin”) of real-world objects.

### BACKGROUND OF THE INVENTION

Accurate capture of the three-dimensional shape, visual appearance, and material composition of real-world objects can facilitate the creation of realistic digital representations. These realistic digital representations can be used to enhance our understanding of and interaction with real-world objects and can have significant implications for numerous different real-world and virtual-world applications, including but not limited to:
Analysis/Recognition: Accurate acquisition of object shape, appearance, and materials enables advanced analysis and recognition techniques. Computer vision systems can utilize this information to identify and understand objects in images or videos. This has applications in fields such as object recognition, scene understanding, and image-based search.
Visual Effects, Games, and Virtual Reality: The entertainment industry benefits greatly from acquiring the shape, appearance, and materials of real-world objects. By capturing these characteristics, visual effects artists can seamlessly integrate virtual elements into live-action footage or virtual environments, creating realistic and immersive experiences in movies, games, and virtual reality applications.
Augmented Reality (AR), Mixed Reality (MR), Extended Reality (XR), and the Metaverse: Accurate acquisition of object attributes is crucial for the seamless integration of virtual objects with the real world. AR, MR, XR, and the emerging concept of the metaverse rely on capturing the shape, appearance, and materials of real-world objects to enable realistic virtual object placement, occlusion, and interaction with the real environment.
Cultural Heritage: Preserving and documenting cultural heritage objects and artifacts can greatly benefit from accurate shape, appearance, and material acquisition. By capturing detailed 3-D information, researchers and conservators can create digital archives, perform in-depth analysis, and even restore or recreate damaged or lost objects.
Non-Invasive Medical Screening: This type of screening can play a vital role in preventive healthcare, early detection of diseases, and monitoring of ongoing conditions. It allows healthcare providers to identify potential health issues promptly, leading to timely interventions, treatments, or further diagnostic investigations as needed. Additionally, non-invasive screening methods often offer a more comfortable experience for patients, reduce the risk of complications, and are generally more cost-effective compared to invasive procedures.
Advertising, Engineering, and Design: Acquiring the shape, appearance, and materials of real-world objects plays a vital role in various fields. In advertising, it allows for realistic product visualizations and simulations. In engineering and design, it enables virtual prototyping, non-destructive investigation and testing, evaluation of aesthetics and functionality, and realistic lighting simulations.
Authentication and Tracking of Identity/Origin/Provenance: Enhanced high-fidelity realistic three-dimensional digital representations for real-world objects can be useful as enhanced unique non-reproducible signatures/fingerprints for identifying and tracking unique objects on a blockchain as described in U.S. Pat. No. 10,469,250 B2 (“the '250 Patent”), the disclosure of which is incorporated herein by reference in its entirety.

### SUMMARY OF THE INVENTION

The present invention is directed to enhancements in material composition analysis and discernment of layering structures to achieve enhanced high-fidelity digital representations of real-world objects. According to the invention, real-world objects are analyzed using spectral imaging, 3-D scanning, and one or more polarization filter(s) to determine the physical features and material layering structure up to the optical window of the material in conjunction with the emitted radiance of the light source. The result is a fifth-dimension object acquisition system (3-D, Spectral, and Polarimetric fusion and analysis techniques), that produces enhanced high-fidelity three-dimensional digital copies of real-world objects. For the purposes of this invention the term “real-world objects” is intended to cover any physical object in the physical world, including any plant, animal or thing. The term “real-world” is used herein to distinguish “real-world objects” from digital/virtual representations thereof. The apparatus and method of the invention generate enhanced high-fidelity digital representations of real-world objects from 3-D scan data and spectral analysis data at various polarization states.

The method and system of the invention produces enhanced high quality renderings of scanned objects at a wave and quantum-optics-accurate level with polarization attributes accounted for under new lighting conditions and without risk of exposing the genuine article to environmental conditions. The invention is particularly suited for use in connection with applications where physically correct material properties is required for display (e.g., game engines) and/or for analysis in a physically correct manner (e.g., physics simulations).

The device/system/apparatus according to the invention preferably includes, a light source, a spectral imager, a range scanner, one or more polarization filter(s), motors to move the polarization filters relative to the light source and the spectral imager, a calibration target, and a mounting and movement mechanism/mobile platform configured to mount at least the spectral imager, the range scanner, the polarization filters, and the polarization motors, and to move them and the object being analyzed relative to one-another. That is, the analysis devices may be configured to move around a stationary object, or the analysis devices may remain stationary and the object may be rotated or moved, or some combination thereof. The device may be sized according to the size of the objects for analysis. Accordingly, the device may be sized to rest on a table; it may be sized to stand on the ground; it may be the size of a room or even larger; or it may be mounted to a moving or flying structure. In the case of a structure that is configured to remain in one place during operation, the mounting and movement frame may be one or more of a movable platter, platform, gantry, or the like. In the case of a moving system (for example, where the object under analysis cannot be rotated, due to size, location or other factor), the spectral imager, polarization filter(s) and polarization motors may be mounted to a land or water-based vehicle or on a drone or other aerial vehicle/airborne frame. The device may optionally include a high-definition camera and/or a mass scale.

The present invention provides for enhanced high-fidelity three-dimensional (3-D) virtual representations of real-world objects. These digital twins reflect information not available with prior art systems, including areas of physical stress on the material (e.g., stress patterns on dielectric materials such as bending, warping, fractures, etc.), multi-layered, layer-by-layer, reconstruction based on material properties, such as the human body, manufactured parts/assemblies, building structures, as well as sub-surface structurally colored materials (such as the morpho butterfly or the Lexus Structural Blue paint).

This invention presents significant improvements to prior art virtual/digital copies of real-world objects particularly concerning material composition analysis and discernment of layering structures, especially for real-world objects made of materials where reflectance, transmittance, and absorption all play strong roles in material properties. The polarization also provides improved spectral boundary determination for the spectral components of the apparatus, producing a higher detail geometric capture for the spectral datacube. This invention could be used for the creation of enhanced high-fidelity digital twins and historical archives for cultural heritage sites (e.g., the Great Pyramids, the Eiffel Tower, etc.) as a function of time of those objects (e.g., future generations could see the Great Pyramids as they appeared when the first scan was produced and compare it to future scans, thus allowing for an archival scheme that provides the ability to discern changes over time at a material and chemical composition level of those objects).

Accordingly, there is provided according to an embodiment of the invention, a device for generating enhanced high-fidelity three-dimensional digital copies of real-world objects including: one or more processing devices; a storage device, coupled to the one or more processing devices and storing instructions for execution by at least some of the one or more processing devices; a spectral imager to assess the spectral hypercube data of the real-world object, identifying anomalies, defects, imperfections, noise and geometric irregularities in composition of the real-world object; at least one polarizer filter; one motor per polarizer for division of time filtering; a light source to provide broad spectrum illumination on the real-world object; a range scanner to assess the 3-D spatial data of the object; a polarization state-dependent calibration target to determine a geometric relationship between the range scanner and the spectral imager and perform polarimetric-radiometric calibration; a mechanism of movement/mobile platform to move the real-world object and assessment devices relative to one another to allow a 360-degree assessment of the real-world object; wherein the one or more processing devices operate to configure the device to analyze an instance of a real-world object to generate a three-dimensional digital representation of the real-world object from the spectral analysis data, 3-D scan data and polarimetric data; and wherein the item analysis components determines the spectral hypercube data of the real-world object, including identifying individual layer composition and structure, and determining each layer at which sub-surface anomalies, defects, imperfections, noise and geometric irregularities in composition of the real-world object exist. According to further embodiments, the device may include an HD photography camera and/or a scale to determine a mass of the real-world object. The device may further include a housing or frame onto or into which the spectral imager, polarizer filter, and range scanner are mounted. According to various embodiments, the housing or frame may be capable of flight.

According to further embodiments, a dynamically movable polarization state-dependent calibration target may be used to determine a geometric relationship between the range scanner and the imager and perform polarimetric-radiometric calibration.

According to still further embodiments, the device may include a location determination device configured to receive signals via a communication subsystem with which to determine a position of the device.

According to other embodiments, the real-world object may be a modified real-world object defined from a previously recorded real-world object.

According to preferred embodiments, the spectral imager, the range scanner and the polarizer may be configured to measure surface and sub-surface physical features including any of anomalies, defects, imperfections, noise and geometric irregularities that are either naturally occurring or human made through a process to produce a unique non-reproducible randomness that uniquely identifies the real-world object.

According to further preferred embodiments, the device may be configured to capture and optionally export 3-D scan data, spectral analysis data, and polarization states S₀, S₁, and S₂ by capturing four polarization angles at αϵ{0°, 45°, 90°, 135°}, or three polarization angles αϵ{0°, 90°, 135°} along with an unfiltered capture.

There is also presented according to the invention, a computer implemented method for generating enhanced high-fidelity three-dimensional digital representations of real-world objects including: measuring and collecting from a real-world object spectral hypercube data, polarization states, and 3-D spatial data, using a spectral imager, at least one polarizer, and a range scanner, respectively, through 360 degrees about the real-world object under control of computer-readable instructions stored on non-transient storage media executed by a processor, the measuring and collecting spectral hypercube data, polarization states, and 3-D spatial data including identifying anomalies, defects, imperfections, noise and geometric irregularities in composition of the real-word object, and including identifying individual layer composition and structure, and determining each layer at which sub-surface anomalies, defects, imperfections, noise and geometric irregularities in composition of the real-world object exist; and generating, by the processor under control of the computer-readable instructions using the spectral hypercube data, the polarization states, and the 3-D spatial data, a digital representation of the real-world object, the digital representation including data specifically reflecting surface anomalies, defects, imperfections, noise and geometric irregularities in the real-world object, as well as sub-surface individual layer composition and structure, and sub-surface anomalies, defects, imperfections, noise and geometric irregularities in composition of the real-world object.

The computer implemented method may further include collecting photographic and mass data from the real-world object, and optionally using the photographic and mass data in the generating step.

According to various embodiments of the computer implemented method of the invention, the spectral imager, the at least one polarizer, and the range scanner, may be mounted on a moving device and the measuring and collecting step may take place at least partially during movement of the moving device. The moving device may be a flying device, and the measuring and collecting step may take place at least partially during flying of the flying device.

According to preferred embodiments of the computer implemented method of the invention, a dynamically movable polarization state-dependent calibration target may determine a geometric relationship between the range scanner and the imager and perform polarimetric-radiometric calibration.

Other embodiments of the invention may include moving the spectral imager, the at least one polarizer, and the range scanner about the real-world object during the collection step and collecting location data from a location determination system to determine positions and movement of the spectral imager, the at least one polarizer and the range scanner.

Still further embodiments of the invention include capturing polarization states S₀, S₁, and S₂ by capturing four polarization angles at αϵ{0°, 45°, 90°, 135°}, or three polarization angles αϵ{0°, 90°, 135°} along with an unfiltered capture.

It is specifically noted that every combination and sub-combination of the above-listed and below-described features and embodiments is considered to be part of the invention.

### BRIEF DESCRIPTION OF DRAWINGS

FIG. 1 is a block diagram showing components of a device/assembly according to an embodiment of the invention.

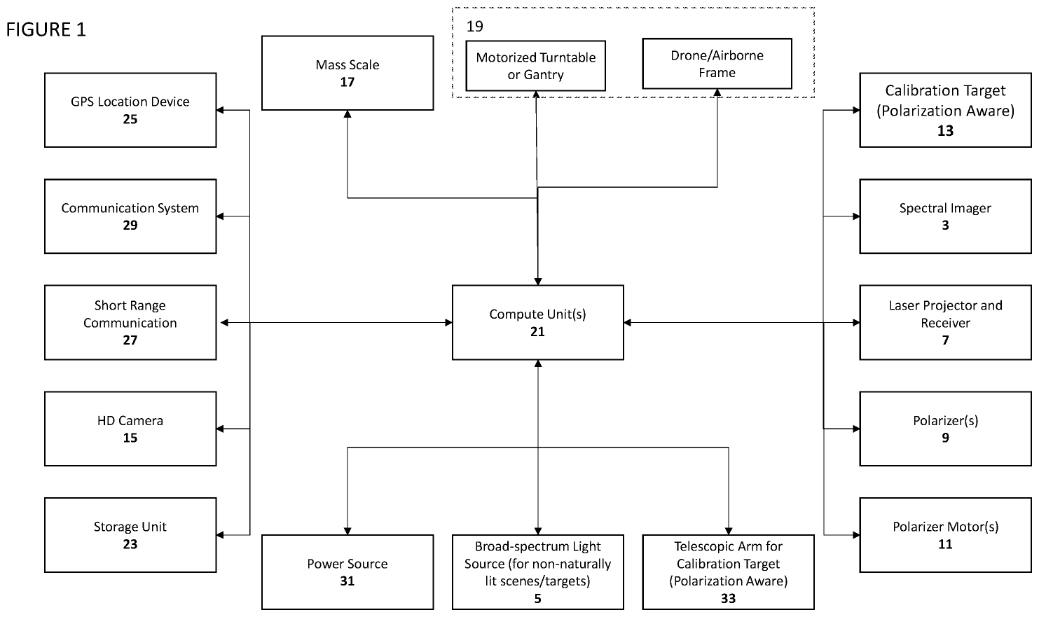

### DETAILED DESCRIPTION OF THE INVENTION

Referring to the FIGURES, spectral imager 3 is used to assess the spectral hypercube data of the real-world object, identifying anomalies, defects, imperfections, noise and geometric irregularities in composition of the real-world object, notably the radiometric measurements at various spatial frequencies. Light source 5 provides broad spectrum illumination on the real-world object. In the case of an enclosed or indoor system, a Xenon-based light-source is preferred due to its relatively flat spectral response curve over the relevant portions of the electromagnetic spectrum, but any light source may be used for which the spectral system is responsive in the UV A/B to IR ranges, including natural sunlight. Range scanner 7 (e.g., 3-D LIDAR laser based/laser projector and receiver) is used to record the 3-D spatial data of the object.

One or more polarization filter(s) 9 are provided to capture polarization states (specifically S₀, S₁, and S₂), either by capturing four polarization angles at αϵ{0°, 45°, 90°, 135°}, or by capturing three polarization angles at αϵ{0°, 90°, 135°} along with an unfiltered capture. According to one embodiment, one polarizer 9 can be placed in front of the imager or in front of the light source to achieve polarization-based imaging. According to alternative embodiments, the polarizer 9 may be placed in front of the imager 3 and then overfilling the aperture of the imager 3. In still further embodiments, two polarizers 9 may be used, one in front of the imager 3 and one in front of the light source 5. According to this embodiment, both polarizers may be rotated to perform a nulling process whereby both polarizers are rotated until no light reaches the imager. In this setup, the calibration target can remain as the traditional non-polarization state-based target, as the nulling process inherently calibrates the polarization state of the system.

One or more motors 11 are provided to control the motion of the polarization filter(s) so that they may be rotated to the desired Degree of Polarization (DoP) for division of time filtering techniques. While division of time filtering techniques such as a liquid crystal, linear polarizer, or photo-elastic modulator are used for the calibration of the motor which physically turns/modulates a division of time-based filter, other techniques such as division of amplitude, division of focal plane, etc., can also be used to acquire the same measurements for the analysis where there is no physical component to be controlled. In those cases, the polarization may be achieved through an internal mechanism or on the imaging sensor itself.

A calibration target 13 is provided to determine a geometric relationship between the range scanner 7 and the spectral imager 3 as well as polarization state-dependent calibration points to allow for polarization calibration confirmation. Depending on the application, an HD photography camera 15 may optionally be provided to capture digital images of the external features of the real-world object, and/or a mass scale 17 may be optionally provided to determine a mass of the real-world object. Additionally, a mechanism of movement 19 (e.g., a movable platter, mobile platform or gantry, and/or drone/airborne frame system) is provided to move the real-word object and assessment devices relative to one another to provide for a 360-degree polarimetric enhanced radiometric 3-D object acquisition.

Computing unit(s) 21 provide a processing device or devices to process the 3-D spatial and spectral information and render the digital image, as described, for example, in (Kim, M., Harvey, T., Kittle, D., Rushmeier, H., Dorsey, J., Prum, R., Brady, D. 2012. 3D Imaging Spectroscopy for Measuring 3D Hyperspectral Patterns on Solid Objects. ACM Trans. Graph. 31 4, Article 38 (July 2012), and Pharr, M., Jakob, W., & Humphreys, G. (2017). Physically based rendering: from theory to implementation (3rd ed.). Amsterdam; Boston; Heidelberg: Elsevier, at Chapter 4 with special interest to section 4.1.2. Processing devices may be programmable such as via software (instructions stored in a memory for example) including a Central Processing Unit (CPU) or Graphics Processing Unit (GPU) or specially configured hardware devices such as Application Specific Integrated Circuits (ASICs) & Field Programmable Gate Arrays (FPGAs) or combinations of same. Application Specific Integrated Circuits (ASICs) & Programmable Gate Arrays (PGAs) may be configured to perform specific (dedicated) 10 tasks in a manner that is more efficient and takes less time than a conventionally programmed device.

Storage device 23, for example, non-transient computer-readable memory, is coupled to one or more of the aforementioned computing unit(s) 21, and item assessment devices to receive collected and/or processed data.

Location tracker 25 may be provided to capture geolocation data (GPS data).

Short range communication component 27 (such as Bluetooth, Bluetooth SMART or ZigBee, Wi-Fi Direct or any other shortrange network communication mechanism), may be provided for short-range communication with partner/companion devices and applications, such as mobile apps. Communication system 29 may comprise one or more antennas and one or more wired connections maybe provided to give communication abilities via short range communications and internet (WAN) communications.

Mounting and movement mechanism 19 is configured to mount at least the spectral imager, the range scanner, the polarization filters and the polarization motors, and to move them relative to the object being analyzed. The device may be sized according to the size of the objects for analysis. Accordingly, the device may be sized to rest on a table; it may be sized to stand on the ground; it may be the size of a room or even larger; or it may be mounted to a moving or flying structure. In the case of a structure that is configured to remain at rest during operation, the mounting and movement frame may be one or more of a movable platter, platform, gantry, or the like. In the case of a moving system, the spectral imager, polarization filter(s) and polarization motors may be mounted to a land or water-based vehicle, or on a drone or other aerial vehicle/airborne frame.

In the case of a “drone/airborne frame system,” the real-world object might optionally be weighed using a mass scale 17 which has a visible (e.g., not be obscured by the object and in a position and orientation on the scale where it would be visible when performing a complete rotation around the object) and polarimetric-dependent calibration target, which the drone/airborne frame system would use to establish its calibration requirements including the initial location of the drone/airborne frame system and imaging apparatus relative to the object. When analyzing an object, a calibration target must also be present to allow for the calibration of the optical apparatus, ideally by being mounted on the drone/airframe system (e.g., through an telescopic/extendable single or multi-degrees-of-freedom robotic arm 33) and establish its relative distance to the object by maintaining its Witness node verifiable position in 3-D space and scanning the object being analyzed.

Power source 31 provides required power to each of the aforementioned elements.

### Overview Example: Medical Application

The human body has many unique properties and mechanics which occur in the sub-epidermal regions. Known no-contact optical modalities such as Magnetic Resonance Imaging (MRI) and X-Ray/CT Scan expose patients to short wavelength ionizing radiation and complications from injected dyes to discriminate areas of interest, require costly equipment and specialized expertise to operate, and are immobile apparatuses that require large specialized facilities. The analysis performed by the apparatus disclosed in the present invention offers a method for non-invasive medical analysis through the use of the combined 3-D geometric-spectral measurements with polarimetric data, which provides improved discernment of layering structures, identifying for example areas of sudden change in composition of tissue/blood/arteries at various wavelengths, subsurface structures of the human body which are up to and partly contained in the hypodermis layer below the surface such as nerves and blood vessels, various types of surface properties such as physiological changes that occur from the human body's general exposure to an environment such as sunlight/UV exposure. This would allow for a fast, affordable, and safe analysis/screening mechanism for a variety of conditions which are spectrally discernable (e.g., early detection of skin cancer, monitoring healing of wounds over time, distinguishing between healthy and anomalous tissue, blood flow related analysis). In the present invention, the 3-D geometric-spectral polarimetric data would allow, by applying the methods described in the '250 patent, to determine at each scan relative changes that have occurred between prior scans performed on the patient (e.g., wound healing over time, new injuries or tissue damage, natural changes in tissue damage from environmental exposure). The apparatus would therefore allow the determination, analysis and reconstruction of the layer structure, at each individual layer, until the light is fully absorbed by the body. For the first time, it would be possible to not only identify the presence of a sub-surface anomaly but also its depth and at which layer the anomaly occurs. As such, an occurrence of shallow depth anomalies could be detected reliably at each scan, as well as its progress to potentially further locations without the need for the use of MRI and X-Ray/CT scans.

The 3-D geometric-spectral polarimetric data can be used to generate a more detailed/enhanced unique signature for the patient. In addition, or alternative, 3-D geometric-spectral polarimetric data may be used with a physically correct rendering engine to provide a more detailed digital representation of the patient, which can be further used for highly accurate visual representations of the patient by providing a complex material and absorption aware 3-D model for medical guidance and this in turn could be used with VR/AR/MR/XR techniques where the virtual environments for investigating the patient are beneficial and could provide more clarity for prognosis, consultation, and/or surgery.

### Overview Example: Supply Chain

Manufactured parts which make up a greater whole (e.g., bolts, nuts, gears, plating, sub-frames, frames, hinges, windows, handles, molding, inner panel, etc.) are the foundation of engineered machine parts in all industries such as the automotive and aerospace industries, etc. All the individual constituent components which compose part of a vehicle assembly, such as a door, can be individually tracked and uniquely identified from all other mass-produced doors for the same model vehicle by applying the concepts of the '250 patent, thus allowing a car manufacturer, to track the individual parts that make up the entire vehicle.

A finished vehicle generally receives several coatings, a clearcoat (roughly 50 μm), a base coat (20 μm), a primer coat (25 μm), an electro-coat (25 μm), followed sometimes by a phosphate/pretreatment (1 μm), and finally the alloy/steel/carbon fiber panel (referred to as the substrate).

These coatings/layers are too thin to be discerned by traditional photometric techniques due to their thin-film nature. However, spectral imaging allows for identifying and locating the various components as the light interacts with the different layers and the layers are spectrally unmixed making it is possible to determine the existence and chemical composition properties of each of these individual layers until the light is fully absorbed by the alloy/steel panel. However, some of the well-used spectral unmixing models fail when dealing with materials which have similar light-matter interaction properties and shared boundaries. In the present invention, the use of one or more polarizer(s) allows for the direct computation of the complex valued properties of constituent layers and for better discrimination of boundaries where materials may have similar refraction properties, as it allows for the tuning of the system to be optimized for better transmittance at the various layers and the use of nulling techniques. The apparatus would therefore allow the determination, analysis and reconstruction of the layering structure, at each individual layer, until the light is fully absorbed by the substrate. Therefore, it would be possible to identify the presence of sub-surface elements and the composition and depth of the layer, as well as at which layer the anomaly exists.

The 3-D geometric-spectral polarimetric data for all the constituent parts can be used to generate a more detailed/enhanced unique signature for each item. In addition, or alternative, the 3-D geometric-spectral polarimetric data may be used with a physically correct rendering engine for the purposes of a physically correct display of the entire product and/or any of its sub-components or with a physics engine to simulate physical phenomena (e.g., thermodynamic, electromechanical, magnetoelastic, magnetothermal, electrothermal, electromechanical, thermoelastic, and magnetoelectric).

The 3-D geometric-spectral polarimetric data (with depth penetration of roughly up to the substrate layer in complex manufactured goods) might also be used with a physically correct rendering engine for the purpose of displaying a physically correct digital twin of the product, where it may not be possible to display the actual product (i.e., a limited-edition variant of the vehicle, or if it is impractical to showcase the vehicle at a dealership) without exposing the product to any risks. Furthermore, the analysis data could be used in VR/AR/MR/XR environments for maintenance and inspections where damage to various components can be visualized in a physically correct manner and guided maintenance could be performed.

The 3-D geometric-spectral polarimetric data can be used with a physics engine, where the car manufacturers would benefit from the ability of having digital twin variants of their product offerings or new concepts for research and development and quality assurance and control, whereby constituent components, material composition and the simulation of physical phenomena (e.g., thermodynamic, electromechanical, magnetoelastic, magnetothermal, electrothermal, electromechanical, thermoelastic, and magnetoelectric) can be tested virtually in a non-destructive, non-invasive, and non-contact environment.

### Overview Example: Cultural Heritage Sites

Large cultural heritage sites, such as the Great Pyramids, the Eiffel Tower, etc., are examples of high value large-scale objects which could benefit from a temporal digital twin archival scheme can be used as examples to demonstrate the drone/airborne frame variant of the nodes. Such a temporal digital twin would allow for the duplication and comparison of for example structural components, pigmentation applied to parts of the structure, or any restoration work, so that even if the object is later destroyed due to armed conflicts or natural disaster, a complete and physically accurate digital twin would still be available for humanity. Furthermore, these cultural heritage objects are often studied through spectral unmixing, and some of the well-used spectral unmixing models fail when dealing with materials which have similar light-matter interaction properties and shared boundaries. In the present invention, the use of one or more polarizer(s) allows for the direct computation of the complex valued properties of constituent layers and for better discrimination of boundaries where materials may have similar refraction properties, as it allows for the tuning of the system to be optimized for better transmittance at the various layers and the use of nulling techniques. The proposed apparatus would therefore allow the determination, analysis, and reconstruction of the layering structure, at each individual layer, until the light is fully absorbed by the substrate. Therefore, it would be possible to identify the presence of sub-surface elements and the composition and depth of the layer in multi-layered objects, as well as at which layer the anomaly exists, which is of particular importance to highly scattering pigments used on these structures (e.g., layers of tempera, lapis lazurite, etc.).

For objects such as these, at least one drone/airborne frame would initially start the scan process on the ground and perform the calibration steps as required. Before the drone/airborne frame takes off from the ground, geolocation data would be added to verify positions through ground-based witness nodes, maintaining short distance communication and synchronization with one another to verify proof-of-location, and in the event of multiple drones/airborne frames are used, the drones/airborne frames may act as witness nodes to one another during airborne operations in conjunction with the ground-based witness nodes to ensure constant short-range communication proof-of-location capability (as per the '250 patent). The drone/airborne frame system would initiate take off and fly in a coordinated flight pattern and may be configured to provide visual odometry of the drone/airborne frame system to verify the flightpath, when changing location (e.g., changing elevation and/or rotation movement around the object) at rates equal to or below the short-range communication range, re-performing the proof-of-location, prior to performing object's data acquisition for individual sections of the object. Once data acquisition for a sub-section has been performed, the drone/airborne frame system would then proceed to move to the next sub-section until a complete rotation or one complete vertical column at each of the various sub-heights has been captured, then proceed in elevation or the next angle of rotation around the object to perform the next sub-section while performing in-flight proof-of-location until the entirety of the object has been captured.

The 3-D geometric-spectral polarimetric data for all the constituent parts can be used to generate a more detailed/enhanced unique signature for each item. In addition, or alternative, the 3-D geometric-spectral polarimetric data may be used with a physically correct rendering engine for the purposes of a physically correct display of the entire product and/or any of its sub-components (i.e., a country may have a virtual national museum space which displays a variety of the cultural heritage pieces to a larger audience) or with a physics engine to simulate physical phenomena (e.g., thermodynamic, electromechanical, magnetoelastic, magnetothermal, electrothermal, electromechanical, thermoelastic, and magnetoelectric).

The 3-D geometric-spectral polarimetric data (with depth penetration of the light source) might also be used with a physically correct rendering engine, for the purpose of displaying a physically correct digital twin of the product where it may not be possible to display the actual product (i.e., where a segment of or the whole cultural heritage site has been destroyed, or if it is impractical to showcase the segment of or the whole cultural heritage without exposing it to further degradation, as often things such as murals and paintings on these structures can begin to quickly deteriorate under some lighting conditions). Furthermore, the analysis data may be used in VR/AR/MR/XR environments for maintenance and inspections where damage to various components can be visualized in a physically correct manner and guided maintenance can be performed.

For the acquisition and calculation of 3-D spatial mapping from 3-D scan data, spectral analysis data, and polarization states generated by the item analysis components, location based meta-data may be added as it may be useful to identify the flight path (known as visual odometry) of the optical apparatus/drone/airframe system such that it is possible to track the imaging systems relative movement from one position to another, by verifying the flight path positions reported by location sensors, which can be further enhanced by classic odometrical techniques such as encoders, gyroscopes, drone/airframe system angle, speed and other such systems for drone/airframe systems to give greater confidence in the reported path.

1. A Device for generating enhanced high-fidelity three-dimensional digital copies of real-world objects comprising:
one or more processing devices;
a storage device, coupled to the one or more processing devices and storing instructions for execution by at least some of the one or more processing devices;
a spectral imager to assess the spectral hypercube data of a real-world object, identifying anomalies, defects, imperfections, noise and geometric irregularities in composition of the real-world object;
at least one polarizer filter;
one motor per polarizer for division of time filtering;
a light source to provide broad spectrum illumination on the real-world object;
a range scanner to assess the 3-D spatial data of the real-world object;
a polarization state-dependent calibration target to determine a geometric relationship between said range scanner and said spectral imager and perform polarimetric-radiometric calibration;
a mechanism of movement to move the real-world object and assessment devices relative to one another to allow a 360-degree assessment of the real-world object;
wherein the one or more processing devices operate to configure the device to analyze an instance of the real-world object to generate a three-dimensional digital representation of the real-world object from the spectral analysis data, 3-D scan data and polarimetric data;
wherein the item analysis components determines the spectral hypercube data of the real-world object, including identifying individual layer composition and structure, and determining each layer at which sub-surface anomalies, defects, imperfections, noise and geometric irregularities in composition of the real-world object exist.

2. The device of claim 1 wherein further comprising one or more of:
an HD photography camera;
a scale to determine a mass of the real-world object.

3. The device according to claim 1, further comprising a housing or frame onto or into which said spectral imager, polarizer filter, and range scanner are mounted.

4. The device according to claim 1, wherein the housing or frame is capable of flight.

5. The device according to claim 1, wherein a dynamically movable polarization state-dependent calibration target determines a geometric relationship between said range scanner and said imager and performs polarimetric-radiometric calibration.

6. The device according to claim 1, further comprising a location determination device configured to receive signals via a communication subsystem with which to determine a position of the device.

7. The device according to claim 1, wherein the real-world object is a modified real-world object defined from a previously recorded real-world object.

8. The device according to claim 1, wherein spectral imager, the range scanner and the polarizer are configured to measure surface and sub-surface physical features comprising any of anomalies, defects, imperfections, noise and geometric irregularities that are either naturally occurring or human made through a process to produce a unique non-reproducible randomness that uniquely identifies the real-world object.

9. The device according to claim 1, wherein the device is configured to capture and optionally export 3-D scan data, spectral analysis data, polarization states S_0, S_1, and S_2 by capturing four polarization angles at αϵ{0\hat{ }°, 45\hat{ }°, 90\hat{ }°, 135\hat{ }°}, or three polarization angles αϵ{0\hat{ }°, 90\hat{ }°, 135\hat{ }°} along with an unfiltered capture.

10. A computer implemented method for generating enhanced high-fidelity three-dimensional digital representations of real-world objects comprising:
measuring and collecting from a real-world object spectral hypercube data, polarization states, and 3-D spatial data, using a spectral imager, at least one polarizer, and a range scanner, respectively, through 360 degrees about said real-world object under control of computer readable instructions stored on non-transient storage media executed by a processor, said measuring and collecting spectral hypercube data, polarization states, and 3-D spatial data including identifying anomalies, defects, imperfections, noise and geometric irregularities in composition of the real-word object, and including identifying individual layer composition and structure, and determining each layer at which sub-surface anomalies, defects, imperfections, noise and geometric irregularities in composition of the real-world object exist;
generating, by said processor under control of said computer-readable instructions using said spectral hypercube data, said polarization states, and said 3-D spatial data, a digital representation of said real-world object, said digital representation including data specifically reflecting surface anomalies, defects, imperfections, noise and geometric irregularities in said real-world object, as well as sub-surface individual layer composition and structure, and sub-surface anomalies, defects, imperfections, noise and geometric irregularities in composition of the real-world object.

11. The computer implemented method of claim 10, further including collecting photographic and mass data from said real-world object, and optionally using said photographic and mass data in said generating step.

12. The computer implemented method according to claim 10, wherein said spectral imager, said at least one polarizer, and said range scanner, are mounted on a moving device and said measuring and collecting step takes place at least partially during movement of said moving device.

13. The computer implemented method according to claim 10, wherein said moving device is a flying device, and said measuring and collecting step takes place at least partially during flying of said flying device.

14. The computer implemented method according to claim 10, wherein a dynamically movable polarization state-dependent calibration target determines a geometric relationship between said range scanner and said imager and performs polarimetric-radiometric calibration.

15. The computer implemented method according to claim 10, further comprising moving said spectral imager, said at least one polarizer, and said range scanner about said real-world object during said collection step and collecting location data from a location determination system to determine positions and movement of said spectral imager, said at least one polarizer and said range scanner.

16. The computer implemented method according to claim 10, further comprising capturing polarization states S₀, S₁, and S₀ by capturing four polarization angles at αϵ{0°, 45°, 90°, 135°}, or three polarization angles αϵ(0°, 90°, 135°).

17. An apparatus comprising:
a housing,
an HD camera mounted in or on said housing,
a spectral imager mounted in or on said housing,
a polarizer filter mounted in or on said housing,
a polarizer filter motor arranged to drive said polarizer filter,
a light source mounted in said housing,
a range scanner mounted in or on said housing,
a polarization state-dependent calibration target mounted in or on said housing,
a specimen holder mounted in or on said housing,
a power source,
a turntable or gantry system mounted in or on said housing,
a processor in electronic communication with said scale, said HD camera, said spectral imager, said polarizer filter, said light source, and said range scanner,
a non-transient computer-readable memory in digital communication with one or more of said processor, said scale, said HD camera, said spectral imager, said polarizer filter, and said range scanner,
said non-transient computer-readable memory containing a plurality of unique three-dimensional digital representations of physical objects, said unique three-dimensional digital representations of physical objects each comprising a digital combination of digital HD photographic images, digital spectral images, polarimetric data and digital 3D scans of one of a plurality of pre-recorded specific physical objects.

18. The apparatus of claim 17 further comprising a scale mounted in said housing, wherein:
said processor is in electronic communication with said scale, and said unique three-dimensional digital representations of physical objects each comprises a digital combination of mass determination, digital HD photographic images, digital spectral images, polarimetric data and digital 3D scans of one of a plurality of pre-recorded specific physical objects

19. The apparatus of claim 17, wherein:
said polarimetric data comprises polarization states S₀, S₁, and S₂ determined from four polarization angles at αϵ(0°, 45°, 90°, 135°), or from three polarization angles αϵ{0°, 90°, 135°} and an unfiltered capture.

20. The apparatus of claim 17, wherein:
said plurality of unique three-dimensional digital representations of physical objects include data specifically reflecting surface anomalies, defects, imperfections, noise and geometric irregularities in said physical objects, as well as sub-surface individual layer composition and structure, and sub-surface anomalies, defects, imperfections, noise and geometric irregularities in composition of said physical objects.

21. The apparatus of claim 17, wherein:
said non-transient computer-readable memory further comprises computer readable instructions which when executed by said processor cause said processor to:
power-on said scale (when present), said HD camera, said spectral imager, said polarizer filter, said polarizer filter motor, said light source and said range scanner,
cause said scale (when present) to determine the mass of a first specimen,
receive a mass determination from said scale (when present) and store said mass determination of said first specimen,
cause said HD camera to take images of said first specimen,
receive digital HD images of said first specimen and store said digital HD images of said specimen,
cause said spectral imager to spectrally image a first specimen,
receive and store a digital spectral image of said first specimen,
cause said range scanner to measure the 3D spatial data of said first specimen,
receive and store a digital 3D scan of said first specimen,
cause said polarizer filter to obtain polarimetric data from said first specimen,
receive and store said polarimetric data from said polarizer filter,
digitally combine said mass determination of said first specimen (when a scale is present), said digital HD images of said first specimen, said digital spectral image of said first specimen, said polarimetric data of said first specimen, and said digital 3D scan of said first specimen into a unique three-dimensional digital representation of said first specimen.

22. The apparatus of claim 21, wherein:
said non-transient computer-readable memory further comprises computer readable instructions which when executed by said processor cause said processor to:
record, or receive from a remote location, a purported unique three-dimensional digital representation of a second specimen,
compare said purported unique three-dimensional digital representation of said second specimen to said plurality of unique three-dimensional digital representations and determine whether said second specimen is identical to one of said plurality of pre-recorded specific physical objects, a piece of one of said plurality of pre-recorded specific physical objects, or a completely different physical object.
